(19) United States
(12) Patent Application Publication
(10) Pub. No.: US 2022/0388161 A1
(43) Pub. Date: Dec. 8, 2022

(54) FORCE MEASUREMENT AND FORCE GENERATION IN REDUNDANT ROBOT MANIPULATORS

(71) Applicant: Franka Emika GmbH, München (DE)

(72) Inventors: Andreas Spenninger, Karlsfeld (DE); Marco Morganti, Garching (DE); Kamal Mohy El Dine, München (DE)

(21) Appl. No.: 17/774,717

(22) PCT Filed: Nov. 19, 2020
(86) PCT No.: PCT/EP2020/082662

§ 371 Date: May 5, 2022

(30) Foreign Application Priority Data
Nov. 21, 2019 (DE) 10 2019 131 400.3

(51) Int. Cl. B25J 9/16

(52) U.S. Cl. CPC B25J 9/1607; B25J 9/1643

(57) ABSTRACT

A robot system including: a robot manipulator that includes links interconnected by joints with degrees of freedom that are at least partially redundant to one another; an operating unit configured to detect an input from a user with respect to at least one selected direction of a force; and a control unit configured to receive the input from the operating unit, determine components of a transpose of a Jacobian matrix associated with a respective selected direction for a predetermined position and/or orientation of a distal end of the robot manipulator in a null space such that a first metric based on the components satisfies one of following criteria: unequal to zero, greater than a specified limit, or a maximum, and control the robot manipulator to move a subset of the links in the null space so as to assume a pose according to the components as determined.

### CROSS-REFERENCE TO RELATED APPLICATIONS

The present application is the U.S. National Phase of PCT/EP2020/082662, filed on 19 Nov. 2020, which claims priority to German Patent Application No. 10 2019 131 400.3, filed on 21 Nov. 2019, the entire contents of which are incorporated herein by reference.

### BACKGROUND

### Field

The invention relates to a robot system including a robot manipulator having a plurality of links interconnected by joints with at least partially redundant degrees of freedom with respect to each other, and a method of operating such a robot manipulator.

### SUMMARY

It is an object of the invention to improve an application and measurement of a force and/or torque acting in a selected direction at a distal end of the robot manipulator.

The invention results from the features of the independent claims. Advantageous further developments and embodiments are the subject of the dependent claims.

A first aspect of the invention relates to a robot system including a robot manipulator and including a control unit for the robot manipulator and including an operating unit, wherein the robot manipulator has a plurality of links connected to one another by joints with degrees of freedom which are at least partially redundant with respect to one another, so that at least a subset of the links of the robot manipulator can be moved in a null space without changing a position and/or orientation of a distal end of the robot manipulator, wherein the operating unit is designed to detect an input from a user with respect to at least one selected direction of a force and/or a torque at the distal end of the robot manipulator and to transmit the detected input to the control unit, wherein the control unit is adapted to determine components of a transpose of a Jacobian matrix associated with the respective selected direction for a predetermined position and/or orientation of the distal end of the robot manipulator in the null space such that a first metric based on the components satisfies one of the following criteria: unequal to zero, greater than a specified limit, maximum; and wherein the control unit is adapted to control the robot manipulator to move the subset of links in the null space to assume a pose according to the determined components of the transpose of the Jacobian matrix.

Preferably, the control unit is configured to determine an external force and/or torque acting on the environment at the distal end of the robot manipulator and/or to control actuators of the robot manipulator to apply an external force and/or torque from the distal end of the robot manipulator to the environment after reaching the pose according to the determined components of the transpose of the Jacobian matrix.

In particular, the control unit is connected to the robot manipulator and is preferably a control unit of the robot manipulator itself, that is, preferably the control unit is arranged on the robot manipulator. The operating unit is also connected to the control unit so that data can be transmitted from the operating unit to the control unit for the robot manipulator. The control unit is used, in particular, to control actuators of the robot manipulator in order to enable appropriate movement of the robot manipulator.

The subset of links of the robot manipulator is movable in a null space without changing a position and/or orientation of a distal end of the robot manipulator. That is, a correspondingly high number of joints with mutually redundant degrees of freedom are provided on the robot manipulator so that, while maintaining the position and/or an orientation of a distal end of the robot manipulator, at least two of the links are movable with respect to an earth-fixed coordinate system. Typically, such redundancy is implemented via an appropriately movable elbow joint of the robot manipulator. Preferably, the robot manipulator has torque sensors at its joints, wherein these torque sensors are designed, in particular, to detect a respective torque at a respective joint. From the totality of the detected torques at the joints of the robot manipulator and with the knowledge of the current pose of the robot manipulator, an external force winder can be determined. The term pose refers to the position of the links in relation to each other, i.e., the relative position and especially the relative orientation of the links in relation to each other.

Depending on the pose of the subset of links in this null space, this is possible in a better or worse way. In a so-called singular pose, none of the torque sensors at the joints of the robot manipulator can detect a corresponding torque because an external force acting on the distal end of the robot manipulator is dissipated into the base or pedestal of the robot manipulator in a straight line through the links without creating a lever arm around the joints. The opposite case would be that a force acts at the distal end of the robot manipulator perpendicular to a common longitudinal axis of the links, so that this force generates a torque at a respective joint of the robot manipulator with a maximum lever arm. In particular, the distal end of the robot manipulator is defined by a reference point on the most distal link of the robot manipulator or, alternatively, preferably on an end effector of the robot manipulator.

The torque sensors at the joints can be selected from the multitude of torque sensors known in the prior art. In particular, the torque sensors are mechanical torque sensors in which a strain of a flexible elastic material, for example, in spokes of the respective torque sensor, is detected, wherein an applied torque can be concluded by knowing the material constants. Furthermore, it is particularly possible to measure a current in an electric motor and to infer from this a torque present in the joint. The measured torque is typically composed of a variety of causes. A first part of the torque results from the kinematic forces and torques, especially the Coriolis acceleration, as well as the centrifugal acceleration. Another part of the measured torque can be attributed to a gravity effect. While the torque sensors at the joints measure the detected torques, the forces and torques caused by gravity and kinematics lead to the expected torques. This means that, depending on the current speed of movement and also the current acceleration of the robot manipulator, these torques can be determined according to theory together with a gravitational influence on the robot manipulator and subtracted from the measured torques to the respective torque sensor. This is typically done in an impulse observer whose output is the external torques.

In order to infer from the external torques thus determined an external force winder with any reference, the pseudoinverse of the transformed Jacobian matrix is required. The pseudo inverse (instead of the inverse itself) is particularly necessary if the robot manipulator is a redundant manipulator, meaning that at least two of the joints connecting the links have redundant degrees of freedom with respect to each other. In particular, in a redundant robot manipulator, links of the robot manipulator can be moved without moving an orientation and a position of the end effector of the robot manipulator. The Jacobian matrix basically links the angular velocities at the joints to the translational and rotational velocity at any point, especially at the distal end of the robot manipulator. In principle, however, it is irrelevant whether velocities are actually considered; thus, the Jacobian matrix can also be used for the relationship between the torques at the joints and the forces and torques at the respective arbitrary point.

The transpose of the Jacobian matrix J, namely J^{T} mediates between the external force winder Fₑₓₜ to the determined external torque Tₑₓₜ as follows:

τₑₓₜ=J^{T}Fₑₓₜ.

In this equation, it can be seen that the external force winder, which typically has three components for an external translational force and three more components for an external torque in Cartesian coordinates with respect to an earth-fixed Cartesian coordinate system, is mapped to the vector of external torques by appropriate matrix multiplication with the transpose of the Jacobian matrix, wherein the vector of external torques is respectively related to torques in the joints of the robot manipulator. Advantageously, in accordance with the first aspect of the invention, selected directions of the external force winders are Fₑₓₜ not mapped to zero in their mapping by the transform of the Jacobian matrix J^{T} to the vector of joint torques, which would be the case in such a singular pose explained above. Then, in particular, the respective column of the transpose of the Jacobian matrix belonging to the corresponding direction would be zero in total or at least a vector norm of this respective column would be zero or close to zero. Thus, the external force winder in this selected direction would map to corresponding zero values in the vector of joint torques according to the above equation. However, by each of the possible conditions for the first metric “unequal to zero, greater than a specified limit, or maximum”, this mapping to zero is prevented, or optimized, depending on the condition for the first metric.

It is therefore an advantageous effect of the invention that directions of forces and torques selected by the user are detected and the pose of the robot manipulator in its null space is aligned in such a way that in exactly these directions a force or torque can be better applied by the robot manipulator at its distal end, and, at the same time, that an external force or torque from the environment on the distal end of the robot manipulator can be better determined in this respective selected direction, in particular, via torque determination at the joints of the robot manipulator.

According to an advantageous embodiment, the components of the transpose of the Jacobian matrix associated with the respective selected direction are listed in a respective column of the transpose of the Jacobian matrix, wherein the first metric is a vector norm of the respective column. The preferred vector norm is the 2-norm. The formation of a vector norm advantageously offers a quick calculation and an intuitively comprehensible key figure for a measure of the components listed in a respective column of the transpose of the Jacobian matrix, which maps exactly one component of the external force winder to the vector of joint torques and thus the vector of external torques with respect to the joints (see above τₑₓₜ).

According to a further advantageous embodiment, the control unit is adapted to determine the respective components of the transpose of the Jacobian matrix based on a gradient-based search using the respective vector norm as an inverse cost function. The inverse cost function may also be called an objective function, since this inverse cost function is intended to be maximized, unlike a true cost function, which is usually intended to be minimized in an optimization. Thus, the purpose of this embodiment is to use a gradient-based search to maximize the respective vector norm associated with the respective selected direction. A gradient-based search iteratively determines a gradient at different search points of the inverse cost function, wherein the next search point in each case is determined by the gradient in terms of the steepest ascent. Such a gradient-based search is a classical method from the field of nonlinear optimization and represents an iterative procedure for optimization problems that are not analytically solvable at first go. Advantageously, the gradient-based search implements a simple algorithm to arrive at an appropriate solution with sufficient convergence.

According to a further advantageous embodiment, the control unit is adapted to determine whether a selection has been made by the user at the operating unit, and in the absence of a selection by the user, to determine all components of the transpose of the Jacobian matrix in the null space such that a second metric based on all components of the transpose of the Jacobian matrix satisfies one of the following criteria: unequal to zero, greater than a specified limit, maximum. According to this embodiment, the first aspect of the invention is extended to check whether a selection has been made at all with respect to such a direction by a user. If such a selection is made by the user, the corresponding components of the respective columns of the transpose of the Jacobian matrix assigned to these directions can be selected at a corresponding distance from zero. However, if no direction is specified, optimization of the transpose of the Jacobian matrix as a whole is desirable, and according to this embodiment is optimized as a whole such that, if possible, a singular pose of the robot manipulator is entirely excluded and an external force or torque is sufficiently mapped onto the vector of joint torques in all directions to reliably detect an external torque or force from an external force winder by torque sensors in the joints of the robot manipulator.

According to a further advantageous embodiment, the control unit is adapted to determine the respective components of the transpose of the Jacobian matrix on the basis of a gradient-based search with the determinants of the matrix product of the Jacobian matrix and the transpose of the Jacobian matrix as an inverse cost function. Preferably, the search direction is determined from the gradient, i.e., the local derivative with respect to the joint angles, of the following term:

$$det ( {JJ}^{T} ) \cdot trace {( {JJ}^{T} )}^{- 1} ( \frac{\partial J}{\partial {q}_{t}^{i}} {J}^{T} + J {( \frac{\partial J}{\partial {q}_{t}^{i}} )}^{T} ) ) .$$

Alternatively, preferably, the search direction is determined from the gradient of the term \sqrt{det(JJ^{T})} or further alternatively preferably from the gradient of the term ∥J^{T}∥, i.e., from the norm of the transpose of the Jacobian matrix.

According to a further advantageous embodiment, the control unit is adapted to control the robot manipulator to move the subset of the links in the zero space to assume the pose according to the determined components of the transpose of the Jacobian matrix upon or after reaching the distal end of the robot manipulator of the predetermined position and/or orientation. According to this embodiment, the distal end of the robot manipulator is first moved to the predetermined position and/or orientation, and then the subset of links in its null space is aligned according to the respective determined components of the transpose of the Jacobian matrix.

According to a further advantageous embodiment, the control unit is adapted to control the robot manipulator to move the subset of the links in the null space to assume the pose according to the determined components of the transpose of the Jacobian matrix during the approach of the distal end of the robot manipulator to the predetermined position and/or orientation. While according to the previous embodiment there is a clear separation between the approach of the distal end of the robot manipulator to the predetermined position and/or orientation with the associated path planning and the alignment of the subset of the links in their null space, according to this embodiment the alignment of the links in their null space is included in the path planning so that all links of the robot manipulator, including those that are movable relative to each other in redundant degrees of freedom, are controlled accordingly. Advantageously, the robot manipulator and, in particular, the subset of links in its null space is in such a pose that external forces or torques can already be detected or applied when the distal end of the robot manipulator is reached at the predetermined position and/or orientation in an optimized manner.

According to a further advantageous embodiment, the control unit is adapted to determine the components of the transpose of the Jacobian matrix associated with the respective selected direction by traversing a plurality of poses through the subset of the links in the null space and by determining a respective transpose of the Jacobian matrix current for a respective pose and by comparing the transposes of the Jacobian matrices for the plurality of poses with each other and by selecting one of the transposes of the Jacobian matrices according to the first or second metric. This embodiment corresponds to an empirical approach in which a corresponding pose is actively searched for by a physical search procedure, for each of these poses a transpose of the Jacobian matrices is calculated, a respective transpose of the Jacobian matrices with respect to their corresponding columns (associated with the selected directions) is examined for the first metric and second metric, respectively, and a pose with a favorable first metric and favorable second metric, respectively, is selected.

According to a further advantageous embodiment, the control unit is adapted to determine the components of the transpose of the Jacobian matrix associated with the respective selected direction by traversing a plurality of poses through the subset of the links in the null space and by determining a respective transpose of the Jacobian matrix current for a respective pose and by comparing the transposes of the Jacobian matrices for the plurality of poses with each other and by selecting one of the transposes of the Jacobian matrices according to the first or second metric. In contrast to the previous embodiment, in which the subset of links is actually moved in its null space, according to this embodiment only a simulation of such an action takes place, so that advantageously the corresponding pose can be found in a shorter time.

Another aspect of the invention relates to a method of operating a robot manipulator having a plurality of links interconnected by joints with at least partially redundant degrees of freedom with respect to each other, such that at least a subset of the links of the robot manipulator is movable in a null space without changing a position and/or orientation of a distal end of the robot manipulator, the method including:
Detecting an input from a user with respect to at least one selected direction of a force and/or a torque at the distal end of the robot manipulator by an operating unit connected to the control unit and transmitting the detected input to the control unit,
Determining of components of a transpose of a Jacobian matrix associated with the respective selected direction for a predetermined position and/or orientation of the distal end of the robot manipulator in the null space such that a first metric based on the components satisfies one of the following criteria: unequal to zero, greater than a specified limit, maximum; and
Controlling the robot manipulator to move the subset of links in the null space to assume a pose according to the determined components of the transpose of the Jacobian matrix by the control unit.

Preferably, the method further includes:
After reaching the pose according to the determined components of the transposed of the Jacobian matrix: Determining an external force and/or torque acting on the environment at the distal end of the robot manipulator, and/or controlling actuators of the robot manipulator to apply an external force and/or torque from the distal end of the robot manipulator to the environment.

Advantages and preferred developments of the proposed method result from an analogous and sensible transfer of the explanations given above in connection with the proposed method.

Further advantages, features, and details result from the following description, in which—possibly with reference to the drawings—at least one embodiment example is described in detail. Identical, similar, and/or functionally identical parts are provided with the same reference signs.

### BRIEF DESCRIPTION OF THE DRAWINGS

In the drawings:

FIG. 1 shows a robot system according to an embodiment of the invention, and

FIG. 2 shows a method according to a further embodiment of the invention.

The representations in the figures are schematic and not to scale.

### DETAILED DESCRIPTION

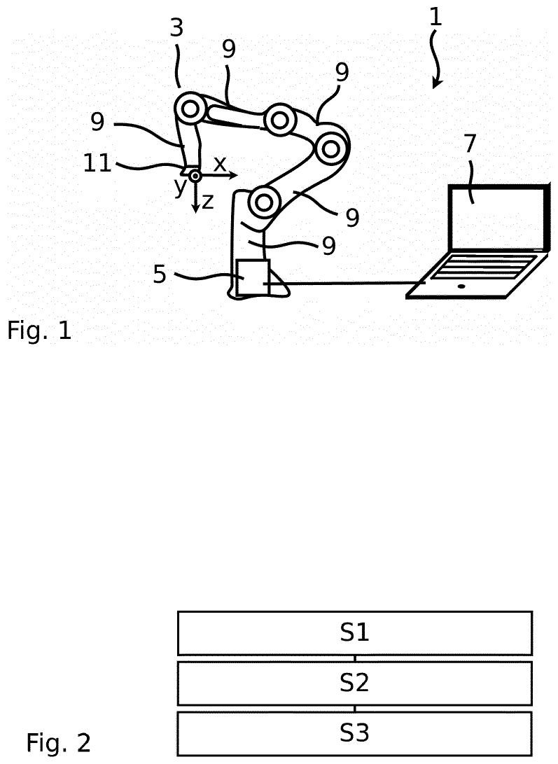

FIG. 1 shows a robot system 1 with a robot manipulator 3 and with an operating unit 7, wherein the robot manipulator 3 has a control unit 5. The robot manipulator 3 has a plurality of links 9 interconnected by joints, some of which have redundant degrees of freedom with respect to each other. Thus, a subset of the links 9 of the robot manipulator 3 is movable in a null space, that is, without changing a position of a distal end 11 of the robot manipulator 3. The operating unit 7 is a user computer connected to the control unit 5 of the robot manipulator 3, and serves for detecting an input from a user with respect to at least a selected direction of a force or torque applied at the distal end 11 of the robot manipulator 3, and for transmitting the detected input to the control unit 5. The control unit 5 determines components of a transpose of a Jacobian matrix associated with the respective selected direction for a predetermined position of the distal end 11 of the robot manipulator 3 in the null space such that a first metric based on the components satisfies the criterion of “greater than a specified limit”. Torque sensors are arranged at the joints of the robot manipulator 3, which in their entirety detect a vector of joint torques at the robot manipulator 3. From the components of this vector, those parts that belong to a vector of external torques are determined; this is done by subtracting the expected torques, in particular, those generated by gravity or dynamic torques from accelerations on the robot manipulator 3. The external torques can come from an external force at the distal end of the manipulator 3 or from an external torque at the distal end of the robot manipulator 3. In order for a corresponding torque to be detected at the torque sensors, such a torque must also be present at the respective joint of the robot manipulator 3. Here, the following relationship shows how the components of the external force winder Fₑₓₜ are mapped on the vector of external torques τₑₓₜ by the transpose of the Jacobian matrix J^{T}:

τₑₓₜ=J^{T}Fₑₓₜ.

If the user now selects the y-direction with respect to a force corresponding to the fifth component of the vector of the external force winder, the fifth column of the transpose of the Jacobian matrix is to be optimized accordingly and a norm of the fifth column as the first metric for this fifth column is to be kept as far as possible from zero, i.e., maximized. Here it is adjustable by the user whether a two-norm or an infinity-norm is used as norm. The above equation thus results in:

$$\begin{matrix}{τ}_{e x t} = & {J}_{11}^{T} & {J}_{12}^{T} & {J}_{13}^{T} & {J}_{14}^{T} & {J}_{15}^{T} & {J}_{16}^{T} & & & \\ & {J}_{21}^{T} & {J}_{22}^{T} & {J}_{23}^{T} & {J}_{24}^{T} & {J}_{25}^{T} & {J}_{26}^{T} & & . & \\ & {J}_{31}^{T} & {J}_{32}^{T} & {J}_{33}^{T} & {J}_{34}^{T} & {J}_{35}^{T} & {J}_{36}^{T} & & . & \\ & {J}_{41}^{T} & {J}_{42}^{T} & {J}_{43}^{T} & {J}_{44}^{T} & [ {J}_{45}^{T} ] & {J}_{46}^{T} & \cdot & ( . ) . & \\ & {J}_{51}^{T} & {J}_{52}^{T} & {J}_{53}^{T} & {J}_{54}^{T} & {J}_{55}^{T} & {J}_{56}^{T} & & {F}_{y} & \\ & {J}_{61}^{T} & {J}_{62}^{T} & {J}_{63}^{T} & {J}_{64}^{T} & {J}_{65}^{T} & {J}_{66}^{T} & & . & \\ & {J}_{71}^{T} & {J}_{72}^{T} & {J}_{73}^{T} & {J}_{74}^{T} & {J}_{75}^{T} & {J}_{76}^{T} & & & \end{matrix}$$

Furthermore, if the x-direction and the z-direction are selected by the user as the respective directions of interest for forces, with the x-direction and the z-direction of a force at the distal end of the robot manipulator 3 occupying the fourth and the sixth component vectors of the external force winders, the fourth and the sixth columns of the transpose of the Jacobian matrix are to be maximized accordingly:

$$\begin{matrix}{τ}_{e x t} = & {J}_{11}^{T} & {J}_{12}^{T} & {J}_{13}^{T} & {J}_{14}^{T} & {J}_{15}^{T} & {J}_{16}^{T} & & . & \\ & {J}_{21}^{T} & {J}_{22}^{T} & {J}_{23}^{T} & {J}_{24}^{T} & {J}_{25}^{T} & {J}_{26}^{T} & & . & \\ & {J}_{31}^{T} & {J}_{32}^{T} & {J}_{33}^{T} & {J}_{34}^{T} & {J}_{35}^{T} & {J}_{36}^{T} & & . & \\ & {J}_{41}^{T} & {J}_{42}^{T} & {J}_{43}^{T} & [ {J}_{44}^{T} ] & {J}_{45}^{T} & [ {J}_{46}^{T} ] & \cdot & ( {F}_{X} ) . & \\ & {J}_{51}^{T} & {J}_{52}^{T} & {J}_{53}^{T} & {J}_{54}^{T} & {J}_{55}^{T} & {J}_{56}^{T} & & . & \\ & {J}_{61}^{T} & {J}_{62}^{T} & {J}_{63}^{T} & {J}_{64}^{T} & {J}_{65}^{T} & {J}_{66}^{T} & & {F}_{Z} & \\ & {J}_{71}^{T} & {J}_{72}^{T} & {J}_{73}^{T} & {J}_{74}^{T} & {J}_{75}^{T} & {J}_{76}^{T} & & & \end{matrix}$$

The control unit 5 thereby determines the respective components of the transpose of the Jacobian matrix on the basis of a gradient-based search using the respective vector norm as the inverse cost function.

FIG. 2 shows a method of operating a robot manipulator 3 having a plurality of links 9 interconnected by joints with at least partially redundant degrees of freedom with respect to each other, such that at least a subset of the links 9 of the robot manipulator 3 is movable in a null space without changing a position and/or orientation of a distal end 11 of the robot manipulator 3, the method including:
Detecting S1 an input from a user with respect to at least one selected direction of a force and/or a torque at the distal end 11 of the robot manipulator 3 by an operating unit 7 connected to the control unit 5 and transmitting the detected input to the control unit 5,
Determining S2 of components of a transpose of a Jacobian matrix associated with the respective selected direction for a predetermined position and/or orientation of the distal end 11 of the robot manipulator 3 in the null space such that a first metric based on the components satisfies one of the following criteria: unequal to zero, greater than a specified limit, maximum; and
Controlling S3 the robot manipulator 3 to move the subset of links 9 in the null space to assume a pose according to the determined components of the transpose of the Jacobian matrix by the control unit 5.

Although the invention has been further illustrated and explained in detail by example embodiments, the invention is not limited by the disclosed examples and other variations may be derived therefrom by a person skilled in the art without departing from the scope of protection of the invention. It is therefore clear that a wide range of variations exists. It is also clear that example embodiments are really only examples which are not to be understood in any way as limiting, for example, the scope of protection, the possibilities of use or the configuration of the invention. Rather, the preceding specification and the figure description enable the person skilled in the art to implement the example embodiments in a concrete manner, wherein the person skilled in the art, being aware of the disclosed inventive idea, can make a variety of changes, for example, with respect to the function or the arrangement of individual elements mentioned in an example embodiment, without leaving the scope of protection defined by the claims and their legal equivalents, such as further explanations in the specification.

### LIST OF REFERENCE NUMERALS

1 Robot system
3 Robot manipulator
5 Control unit
7 Operating unit
9 Links
11 Distal end the robot manipulator
S1 Detecting
S2 Determining
S3 Controlling

1. A robot system comprising:
a robot manipulator that comprises a plurality of links interconnected by joints with at least partially redundant degrees of freedom with respect to each other, such that at least a subset of the links of the robot manipulator is movable in a null space without changing a position and/or orientation of a distal end of the robot manipulator;
an operating unit configured to detect an input of a user with respect to at least one selected direction of a force and/or a torque at the distal end of the robot manipulator and to transmit the input as detected; and
a control unit configured to:
receive the input from the operating unit;
determine components of a transpose of a Jacobian matrix associated with a respective selected direction for a predetermined position and/or orientation of the distal end of the robot manipulator in the null space such that a first metric based on the components satisfies one of a following criteria: unequal to zero, greater than a specified limit, or a maximum; and
control the robot manipulator to move the subset of the links in the null space so as to assume a pose according to the components of the transpose of the Jacobian matrix as determined.

2. The robot system according to claim 1, wherein the components of the transpose of the Jacobian matrix associated with the respective selected direction are listed in a respective column of the transpose of the Jacobian matrix, wherein the first metric is a vector norm of the respective column.

3. The robot system according to claim 2, wherein the control unit is configured to determine respective components of the transpose of the Jacobian matrix based on a gradient-based search using a respective vector norm as an inverse cost function.

4. The robot system according to claim 1, wherein the control unit is configured to:
determine whether a selection has been made by the user at the operating unit; and
in absence of the selection by the user, determine all components of the transpose of the Jacobian matrix in the null space such that a second metric based on all components of the transpose of the Jacobian matrix satisfies one of the following criteria: unequal to zero, greater than the specified limit, the maximum.

5. The robot system according to claim 4, wherein the control unit is configured to determine respective components of the transpose of the Jacobian matrix based on a gradient-based search with the determinants of a matrix product of the Jacobian matrix and the transpose of the Jacobian matrix as an inverse cost function.

6. The robot system according to claim 1, wherein the control unit is configured to control the robot manipulator to move the subset of the links in the null space so as to assume the pose according to the components of the transpose of the Jacobian matrix as determined, upon or after reaching the distal end of the robot manipulator of the predetermined position and/or orientation.

7. The robot system according to claim 1, wherein the control unit is configured to control the robot manipulator to move the subset of the links in the null space so as to assume the pose according to the components of the transpose of the Jacobian matrix as determined, during an approach of the distal end of the robot manipulator to the predetermined position and/or orientation.

8. The robot system according to claim 4, wherein in order to determine the components of the transpose of the Jacobian matrix associated with the respective selected direction, the control unit is configured to:
traverse a plurality of poses through the subset of the links in the null space;
determine a respective transpose of the Jacobian matrix current for a respective pose;
compare transposes of the Jacobian matrices for the plurality of poses with each other; and
select one of the transposes of the Jacobian matrices according to the first metric or the second metric.

9. The robot system according to claim 4, wherein in order to determine the components of the transpose of the Jacobian matrix associated with the respective selected direction, the control unit is configured to:
simulate a plurality of poses of the subset of the links in the null space;
determine a respective transpose of the Jacobian matrix current for a respective pose;
compare the transposes of the Jacobian matrices for the plurality of poses with each other; and
select one of the transposes of the Jacobian matrices according to the first metric or the second metric.

10. A method of operating a robot manipulator having a plurality of links interconnected by joints with at least partially redundant degrees of freedom with respect to each other, such that at least a subset of the links of the robot manipulator is movable in a null space without changing a position and/or orientation of a distal end of the robot manipulator, the method comprising:
detecting, using an operating unit, an input from a user with respect to at least one selected direction of a force and/or a torque at the distal end of the robot manipulator, and transmitting the input as detected;
receiving, using a control unit, the input from the operating unit;
determining, using the control unit, components of a transpose of a Jacobian matrix associated with a respective selected direction for a predetermined position and/or orientation of the distal end of the robot manipulator in the null space such that a first metric based on the components satisfies one of a following criteria: unequal to zero, greater than a specified limit, or a maximum; and
controlling, using the control unit, the robot manipulator to move the subset of the links in the null space so as to assume a pose according to the components of the transpose of the Jacobian matrix as determined.

11. The method according to claim 10, wherein the components of the transpose of the Jacobian matrix associated with the respective selected direction are listed in a respective column of the transpose of the Jacobian matrix, wherein the first metric is a vector norm of the respective column.

12. The method according to claim 11, wherein the method comprises determining respective components of the transpose of the Jacobian matrix based on a gradient-based search using a respective vector norm as an inverse cost function.

13. The method according to claim 10, wherein the method comprises:
determining whether a selection has been made by the user at the operating unit; and
in absence of the selection by the user, determining all components of the transpose of the Jacobian matrix in the null space such that a second metric based on all components of the transpose of the Jacobian matrix satisfies one of the following criteria: unequal to zero, greater than the specified limit, the maximum.

14. The method according to claim 13, wherein the method comprises determining respective components of the transpose of the Jacobian matrix based on a gradient-based search with the determinants of a matrix product of the Jacobian matrix and the transpose of the Jacobian matrix as an inverse cost function.

15. The method according to claim 10, wherein the method comprises controlling the robot manipulator to move the subset of the links in the null space so as to assume the pose according to the components of the transpose of the Jacobian matrix as determined, upon or after reaching the distal end of the robot manipulator of the predetermined position and/or orientation.

16. The method according to claim 10, wherein the method comprises controlling the robot manipulator to move the subset of the links in the null space so as to assume the pose according to the components of the transpose of the Jacobian matrix as determined, during an approach of the distal end of the robot manipulator to the predetermined position and/or orientation.

17. The method according to claim 13, wherein in order to determine the components of the transpose of the Jacobian matrix associated with the respective selected direction, the method comprises:
traversing a plurality of poses through the subset of the links in the null space;
determining a respective transpose of the Jacobian matrix current for a respective pose;
comparing transposes of the Jacobian matrices for the plurality of poses with each other; and
selecting one of the transposes of the Jacobian matrices according to the first metric or the second metric.

18. The method according to claim 13, wherein in order to determine the components of the transpose of the Jacobian matrix associated with the respective selected direction, the method comprises:
simulating a plurality of poses of the subset of the links in the null space;
determining a respective transpose of the Jacobian matrix current for a respective pose;
comparing the transposes of the Jacobian matrices for the plurality of poses with each other; and
selecting one of the transposes of the Jacobian matrices according to the first metric or the second metric.
